(19) United States
(12) Patent Application Publication
(10) Pub. No.: US 2002/0088533 A1
(43) Pub. Date: Jul. 11, 2002

(54) Reinforced shrink wrap and method of manufacture

(75) Inventors: Juanita Mercure, Houston, TX (US); Dave Michalek, Friendswood, TX (US); Dennis Olheiser, Missouri City, TX (US); Thomas Scarborough, Missouri City, TX (US); Troy Taylor, Houston, TX (US); Thomas Sifford, Houston, TX (US)

Correspondence Address: JENKENS & GILCHRIST, A PROFESSIONAL CORPORATION, 1100 LOUISIANA, SUITE 1800, HOUSTON, TX, 77002-5214, US

(73) Assignee: Reef Industries, Inc.

(21) Appl. No.: 10/038,200

(22) Filed: Dec. 21, 2001

Related U.S. Application Data
(62) Division of application No. 09/263,186, filed on Mar. 5, 1999.

(51) Int. Cl. B32B 5/00

(52) U.S. Cl. 156/179; 156/298

(57) ABSTRACT

A reinforced shrink wrap has been developed for use in all types of environments and products or applications. The shrink wrap is tear resistant and can be prepared to withstand exposure from the sun and corrosive elements. The shrink wrap includes a layer of a shrink film and a layer of polyolefin film. In addition, a reinforcing filamentous grid in an extrusion tie layer is disposed in between the shrink film and a polyolefin film.

### PRIOR RELATED APPLICATIONS

This application is divisional application claiming priority to previously filed U.S. patent application Ser. No. 09/263,186, filed on Mar. 5, 1999, which is incorporated by reference herein in its entirety.

### FEDERALLY SPONSORED RESEARCH STATEMENT

Not applicable.

### REFERENCE TO MICROFICHE APPENDIX

Not applicable.

### FIELD OF THE INVENTION

This invention relates to a reinforced shrink wrap.

### BACKGROUND OF THE INVENTION

Shrink wrap is used for a multitude of applications, ranging from wrapping produce in supermarkets to covering containers and products for shipping. The manufacture of shrink wrap may be generally accomplished by extrusion of resinous materials, which have been heated to their flow or melting point from an extrusion die in tubular or planar form. After a post-extrusion quenching, the extrudate is then reheated to its orientation temperature under which it is stretched either uniaxially or biaxially. After being stretched, the film is rapidly cooled to quench and lock-in the oriented molecular configuration. Thereafter, the film may then be stored in rolls and utilized to tightly package a variety of items.

When shrink wrap is in use, the product to be packaged is first enclosed in the shrink wrap, and the enclosed product is subjected to elevated temperatures by passing the product through a hot-air, hot-water tunnel, or other methods. This causes the film to shrink around the product to produce a tight wrapping that closely conforms to the contour of the product.

Because shrink wrap covers the exterior of a product, it is subject to tears, rips, and punctures. Therefore, to obtain a durable shrink-wrapped product, it is important that the shrink wrap should have relatively high tear resistance, puncture resistance, and tensile strength, and other mechanical properties. However, most existing shrink films are unitary in nature, i.e., the entire film is shrinkable. As such, the shrunk film generally has no more strength than the shrink wrap itself. While there are some multi-layered composite shrink wrap, they may not have enough strength or seam integrity to withstand tear and puncture, thereby resulting in delamination, product exposure, or seam breakage. Consequently, it would be desirable to develop a method to manufacture reinforced shrink wrap with improved strength, seam integrity, and other desired properties.

Apart from shrink wrap, reinforced plastic films have been developed that are durable, strong, and puncture-resistant. The plastic films may be reinforced by use of a grid or scrim that has higher strength than the plastic films. In addition to the reinforcing grid, an elastomeric tie layer also has been used to hold the reinforcing grid between the plastic films. To manufacture such reinforced plastic films, an extrusion lamination process has been used. During the extrusion-lamination process, an elastomeric material is extruded from a die to form a tie layer. A reinforcing grid may be imbedded in the tie layer, and the tie layer with the reinforcing grid in sandwiched between two thermoplastic sheets. The entire assembly is then laminated by passing it through a pair of rolls under a certain nip pressure. Such reinforced plastic films are said to possess good mechanical properties, such as puncture resistance, tensile strength, and tear resistance. Furthermore, the reinforced plastic films have good seam sheer strength and peel strength. But these reinforced plastic films are not shrinkable, and thus may not be used as shrink wrap.

Although reinforcing grids with an elastomeric tie layer has been used in manufacturing plastic films, shrink wrap reinforced by an elastomeric tie layer manufactured by a extrusion-lamination process has not been available. This is because there exists a belief that the processing temperature in a typical extrusion-lamination process may be too high for a shrink film that it may start to shrink during the lamination process. Therefore, the benefits of using reinforced grids with an elastomeric tie layer have not been realized in making reinforced shrink wrap.

For the foregoing reasons, there exists a need to explore the possibility of manufacturing reinforced shrink wrap which incorporates the advantages of using a reinforcing grid with an elastomeric tie layer disposed therein. Furthermore, it is desirable to develop a method to achieve such a goal in a simple and cost-effective manner.

### SUMMARY OF THE INVENTION

Embodiments of the invention meet the above need by providing a reinforced shrink wrap and a method of making such shrink wrap. The reinforced shrink wrap may be obtained by the following method: (a) providing two thermoplastic sheets, at least one of the sheets is a shrink film; (b) placing a reinforcing grid between the two thermoplastic sheets; (c) extruding an elastomeric material at an elevated temperature to form a tie layer between the two sheets in which the tie layer is in contact with the reinforcing grid and the two thermoplastic sheets; (d) laminating the two sheets and the reinforcing grid with the tie layer to form a reinforced shrink wrap; and (e) controlling the thickness of the tie layer so that the shrink film does not begin to shrink substantially during laminating. After laminating, the reinforcing grid is held by the elastomeric tie layer between the two thermoplastic sheets.

The reinforced shrink wrap, according to one embodiment of the invention, includes: (1) a first layer of thermoplastic; (2) a second layer of thermoplastic, at least one layer of the first and the second layers include a shrink film of highly-irradiated polyolefin; (3) a reinforcing grid disposed between the first and the second layers of thermoplastic; (4) a tie layer of elastomeric material disposed between the first layer and the second layer holding the reinforcing grid, but allowing slippage of the reinforcing grid in the tie layer upon tensile loading of the reinforced laminate. The first layer, the second layer, the reinforcing grid, and the tie layer are laminated together to form the reinforced shrink wrap.

The shrink film may be made of linear, low-density polyethylene, low-density polyethylene, or mixtures thereof. The elastomeric tie layer may be characterized as having a lower modulus than at least one of the other thermoplastic layers. The thermoplastic film may be a multi-ply film of co-extruded layers. The thermoplastic film or one ply of the film can include additives such as ultraviolet stabilizer, flame retardant, static inhibitor, color additive, antioxidant, corrosion inhibitor, biocide or mixtures thereof. The reinforcing grid may be a non-woven scrim made of nylon, polypropylene, or polyester filaments from about 200 to about 800 denier. The tie layer in which the filamentous grid is disposed may have a thickness from about 0.75 mil to about 1.5 mils.

Moreover, the reinforced shrink wrap may be composed of multiple layers of thermoplastic with more than one grid disposed in a tie layer between the thermoplastic layers. Among these multiple layers of thermoplastic, at least one thermoplastic layer is a shrink film.

### BRIEF DESCRIPTION OF THE DRAWINGS

FIG. 1 is a schematic of a manufacturing process of the reinforced shrink wrap in accordance with one embodiment of the invention.

FIG. 2 is an enlarged cross-section view of one embodiment of the reinforced shrink wrap.

FIG. 3 is an enlarged cross-section view of an alternative embodiment of the reinforced shrink wrap.

FIG. 4 is an enlarged cross-section view of still another embodiment of the reinforced shrink wrap showing multiple layers.

FIG. 5 is an illustration of a pallet of crates covered by the reinforced shrink wrap in accordance with one embodiment of the invention.

### DETAILED DESCRIPTION OF EMBODIMENTS OF THE INVENTION

Embodiments of the invention provide reinforced shrink wrap made by an extrusion-lamination process. The method to manufacture the reinforced shrink wrap includes the following steps: (a) providing two thermoplastic sheets, at least one of the sheets is a shrink film; (b) placing a reinforced grid between the two thermoplastic sheets; (c) extruding an elastomeric material at an elevated temperature to form a tie layer between the two sheets, in which the tie layer is in contact with the reinforcing grid and the two thermoplastic sheets; (d) laminating the two sheets and the reinforcing grid with the tie layer to form a reinforced shrink wrap; and (e) controlling the thickness of the tie layer so that the shrink film does not begin to shrink during laminating. After laminating, the reinforcing grid is held by the elastomeric tie layer between the two thermoplastic sheets.

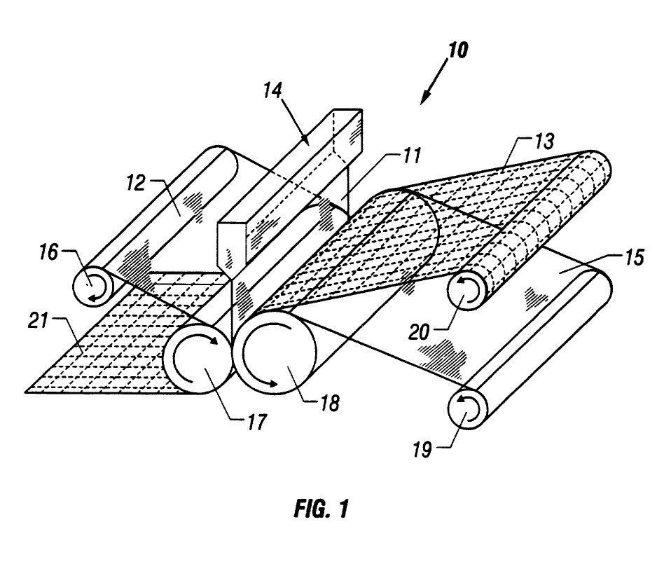

FIG. 1 illustrates an extrusion-lamination setup for making the reinforced shrink wrap in accordance with one embodiment of the invention. Referring to FIG. 1, two thermoplastic sheets 12 and 15 are provided by rolls 16 and 19, respectively. The sheet 12 is a shrink film, whereas the sheet 15 may or may not be a shrink film. A reinforcing grid 13 is provided by a roll 20. An extrusion die 14 extrudes a sheet of elastomeric material 11 to merge with the reinforcing grid 13 which is sandwiched between the two thermoplastic sheets 12 and 15. The extrusion die 14 is heated to at a temperature of about 530° to about 630° F. Preferably, the die temperature ranges from about 550° to about 600° F. The thermoplastic sheets 12 and 15, the tie layer 11, and the reinforcing grid 13 are passed through a pressure roll 18 and a chilled roll 17. The layers are sufficiently pressured to allow adhesion of the outer skin layers around the tie layer and the grid while avoiding excessive pressure that can lead to fusion and thinning of the layers. The outer sheets 12 and 13 are adhered together by the tie layer 11 with the reinforcing grid 13 embedded in the tie layer to form the reinforced laminate 21.

Because the shrink film 12 is used in the lamination process, care should be exercised to control the thickness of the tie layer so that the shrink film 12 would not start to shrink during the lamination process. It is discovered that when the thickness of the tie layer 11 does not exceed a certain value, the shrink film will not start to shrink during the lamination process. The exact maximum thickness value varies, depending on the process conditions and the type of materials used. One way to decrease the thickness of the tie layer 11 is to increase the line speed and/or to decrease the extrusion speed. When the thickness of the tie layer 11 is decreased, less heat is transferred to the shrink film 12. As such, the temperature to which the shrink film 12 is subjected is likely to be lower. Cooling the chilled roll 17 further lowers the temperature of the shrink film 12. In this manner, a shrink film may be successfully laminated with a reinforcing grid, a tie layer, and one or more thermoplastic sheets, without causing substantial shrinkage of the shrink film during the lamination process.

In one embodiment, the reinforced shrink wrap includes: (1) a first layer of thermoplastic; (2) a second layer of thermoplastic, at least one layer of the first and the second layers includes a shrink film of highly-irradiated polyolefin; (3) a reinforcing grid disposed between the first and the second layers of thermoplastic; (4) a tie layer of elastomeric material disposed between the first layer and the second layer holding the reinforcing grid, but allowing slippage of the reinforcing grid in the tie layer upon tensile loading. The first layer, the second layer, the reinforcing grid, and the tie layer are laminated together to form the reinforced shrink wrap.

The reinforced shrink wrap can be customized for its intended use, as will be understood from the following description. The various layers can be modified by thickness and additives as needed. For instance, for applications with large equipment to be shipped on a vessel overseas where there will be exposure to salt spray and other elements, a thicker shrink wrap with a corrosion inhibitor would be preferred. If exposure to the sun is expected, an ultraviolet stabilizer would be desired. Many variations of the invention will be understood by those familiar with the process of lamination.

Any shrink film may be used in embodiments of the invention. Preferably, the shrink film layer is highly irradiated polyolefin such as an ethylene-olefin copolymer, including ethylene-vinyl acetate copolymer. The preferred thickness is from about 0.75 mil to about 1.5 mils and can be varied based on its intended use and desired strength of the final multilayered product.

A preferred shrink film is Cryovac® D-925 film available from Technical Packaging, a distributor for Cryovac North America, Duncan, S.C. Such shrink film is preferred because it has desired physical properties. For example, it shrinks fairly uniformly both in the machine direction and in the transverse direction. It is highly cross-linked from an irradiation process and has the following specifications in Table 1.

TABLE 1
Physical Properties of Cryovac7 D-925 film

| PROPERTY | ASTM | TYPICAL VALUE |
|---|---|---|
| Minimum Use Temp | | 60° F. |
| Maximum Storage Temp | | 90° F. |
| Shrink Temp Air | | 275°-350° F. |
| Density | D-1505 | 0.936 |
| Haze % | D-1003 | 2.0 |
| Gloss % | D-2457 | 90 |
| Ball Burst Impact Strength | D-3420 | 7.1 cm/kg |
| Coefficient of Friction Film to | D-1894 | .24 |
| Film, Kinetic | | |
| Water Vapor Transmission Rate | F-372 | 0.85 gms/100 sq. in/24 hrs. |
| Oxygen Transmission Rate | D-1434 | 4,590 cc/sq. M./24 hrs. |

| PROPERTY | ASTM | LD* | TD** |
|---|---|---|---|
| Tensile Strength | D-882 | 15,000 psi | 15,000 psi |
| Elongation at Break | D-882 | 110% | 140% |
| Modulus of Elasticity | D-882 | 50,000 psi @ | 65,000 psi @ 73° F. |
| | | 73° F. | |
| Tear Propagation | D-1938 | 5.0 grams | 6.0 grams |
| Unrestrained Shrink | D-2732 | | |
| | 200° F. | 10% | 11% |
| | 220° F. | 16% | 26% |
| | 240° F. | 29% | 43% |
| | 260° F. | 80% | 78% |

*Longitudinal Direction
**Transverse Direction

A suitable reinforcing grid may be a non-woven fiber grid. The grid typically is composed of main filaments running in the machine direction and orthogonal filaments running in the transverse direction. Different grid constructions can be obtained by using varying numbers of fibers in the machine and transverse direction. The filaments preferably should have high strength, low shrinkage upon heating, and be able to withstand the temperature of plastic being poured, laminated, or extruded over it. Preferably, filaments used for the construction of this grid are made from polyester, nylon, or polyolefin blends, aramid, fiber glass, and other commonly used filament materials. More preferably, a grid made from either polyester, nylon or fiber glass is used. In the case of polyester, the type of filament used for the construction of the grid is an about 500- about 1,500 denier, high-tenacity, low-shrinkage yarn. Most preferably, the yarn is an about 840- about 1,000 denier type, such as about 787 yarn from Hoechst Celanese, Salisbury, N.C. The grid or scrim may be manufactured by cross-laying the filaments over each other, securing them together by passing through a bath of a tackifier, commonly polyvinyl alcohol, and then drying, rolling, and packaging on a core. This non-weaving process makes possible the construction of a reinforcement fabric with a low count of filament yarns. The grids commonly used for reinforcement of plastic sheets may very from a 20×20 construction to a 1×1 construction (“20×20” means 20 filaments per inch in the machine direction and 20 filaments per inch in the transverse direction). Preferably, the construction used varies from a 5×5 to 1×1. More preferably, the constructions are 3×2 and 2×1.

The reinforcing grid generally is held by a tie layer between two outer sheets. The grid may be embedded or surrounded by the tie layer. The tie layer preferably is a material with a lower modulus than the outer sheets. Certain elastomeric materials with a relatively low modulus include, but are not limited to, butyl rubber, PVC, polyurethane, neoprene, and ethylene propylene diene (EDPM). These materials need to be dissolved in water or solvents for processing. In addition, ethylene methylacetate (EMA) and ethylene vinyl acetate (EVA) have a lower modulus than the polyethylenes and polypropylenes used for laminates.

A group of elastomeric materials suitable for use as a tie layer are polyolefin elastomers manufactured by the co-polymerization of ethylene or propylene with monomers, such as propylene, butene, hexene, octene, methyl acrylate, and vinyl acetate, using either gas-phase or solution process technology. Some examples of suitable elastomeric materials as a tie layer include those referred to as Plastomers (Exxon and Dow) or Catallow resins (Himont). Like elastomers, these polyolefin resins are soft and resilient. On the other hand, they may be processed in the form of free flowing pellets, just like plastics. Polypropylene Catallow resins preferably are used when the outer skin layers are made from polypropylene. Polyethylene plastomer resins preferably are used with polyethylene skin films. Table 2 is a comparison of the physical characteristics and film properties of LDPE, LLDPE, which is used as an outer sheet material, Exact 4044, EMA, and EVA. Exact 4044 is an ethylene-based hexene plastomer made by Exxon Chemical.

TABLE 2

| PHYSICAL CHARACTERISTIC | LDPE | LLDPE | Plastomer Exact 4044 | EMA | EVA |
|---|---|---|---|---|---|
| Density (g/cc) | 0.92 | 0.92 | 0.895 | 0.94 | 0.939 |
| Melt Index (MI) | 1.8 | 0.96 | 16.5 | 1.75 | 1.75 |
| Comonomer (%) | 0 | 6 | 14 | 17 | 17 |
| Melting pt. (° C.) | 110 | 124 | 89 | 85 | 88 |
| Crystallinity (%) | 40-60 | 50-60 | 20-40 | 20-30 | 20-30 |
| FILM PROPERTY | | | | | |
| 1% Secant Modulus (psi) MD | 26900 | 37700 | 9430 | 6900 | 9200 |
| TD | 28700 | 42600 | 8690 | 7400 | 9800 |
| Tensile Strength (psi) | 3760 | 6750 | 8090 | 7400 | 9800 |
| Elongation (%) | 140 | 730 | 480 | 270 | 180 |
| Dart Drop (gm/mil) | 64 | 268 | 1846 | 256 | 449 |
| Elmendorf Tear (gm/mil) MD | 312 | 475 | 314 | 14.4 | 27.2 |
| TD | 144 | 599 | No fail | 224 | 224 |

MD = Machine Direction
TD = Transverse Direction

Suitable polyethylene resins are substantially linear olefins within a narrow molecular weight distribution. Preferably, the density of the polyethylene resins should vary from about 0.860 to about 0.920 g/cc, and the comonomer concentration should vary from about 6% to about 20%. More preferably, the density should range from about 0.890 to about 0.910, with a tensile modulus (1% secant—D882) in the range of about 5,000- about 15,000 psi. Table 3 lists typical physical characteristics and film properties of some polyethylene and polypropylene copolymers that may be used in the tie layer.

TABLE 2

| PHYSICAL CHARACTERISTICS | ASTM | Exxon 4044 | Dow DPT1450 | Himont KS-057P |
|---|---|---|---|---|
| Density (g/cc) | D1505/D-792 | 0.895 | 0.902 | 0.90 |
| Melt Index (MI) | D-1238, E | 16.5 | 7.5 | — |
| MeltFlow (MFR) | D-1238 | — | | 30 |
| Melting Point (° C.) | | 89 | 98 | 141 |
| FILM PROPERTY | | | | |
| 1% Secant Modulus (psi) | D-882 MD | 9430 | — | 6600 |
| | TD | 8690 | — | 5200 |
| Tensile Strength @ Yield (psi) | D-882 MD | 690 | 840 | 770 |
| | TD | 600 | 770 | 600 |
| Tensile Strength @ Break (psi) | D-882 MD | 8090 | 5435 | 1790 |
| | TD | 6440 | 4300 | 1030 |
| Elongation @ Break (%) | D-882 MD | 480 | 620 | 610 |
| | TD | 700 | — | 650 |

MD = Machine Direction
TD = Transverse Direction

Some elastomeric materials used as tie layers tend to be unstable when extruded due to their elastic nature. They may be stabilized by adding about 1-90% of a stabilizing resin. For example, low density polyethylene (LDPE), such as Chevron PE-1017, is added when a very low density polyethylene is used. Typically, addition of about 5-6% LDPE resin is sufficient to significantly improve the processing behavior of these materials.

As discussed above, the thickness of the tie layer should be controlled so that the shrink film will not start to shrink substantially during lamination. Moreover, the thickness of the tie layer also is important for the performance of the product. The tie layer preferably is about 5-25% of the total thickness of the product. More preferably, a tie layer representing about 15-25% of total thickness is used. For example, the thickness of the elastomeric tie layer may be between about 0.75 and 1.5 mil, with a preferred thickness of about 1.0 mil. Additives can be used in the tie layer to impart specific properties, including but not limited to, UV stability, fire retardation, and infrared barriers. Suitable additives may include ultraviolet stabilizer, flame retardant, static inhibitor, color additive, antioxidant, corrosion inhibitor, biocide and mixtures thereof.

The outer layer of the shrink wrap includes a thermoplastic film, preferably from about 0.75 to about 6 mils thick. Additional thermoplastic layers may be used as inner layers disposed between the tie layers with or without reinforcing grids. Suitable thermoplastics include, but are not limited to, polyethylenes, polypropylenes, polyvinyl chloride, polyester, and any other polymers capable of being formed into sheets and laminated by this extrusion process. Preferably, a linear low density polyethylene (LLDPE) and low density polyethylene blend is used because it has good toughness, tear resistance, and puncture resistance.

The thermoplastic film may have two plies or more. When the polyolefin film contains more than one layer, each layer can be made of a different polyolefin or mixtures thereof. For instance, the layer that will be the outer facing surface of the shrink wrap can be low density polyethylene which is amendable to heat sealing and is suitable for fabricating the product covers and also has a good surface appearance. The other layer or layers can be another polyolefin or mixtures. The multi-ply film can be prepared by methods such as co-extruded blown film manufacturing techniques.

In some embodiments, the thermoplastic layers include additives for color and may have a printed message on any layer, if desired. Other additives that can be used include ultraviolet light stabilizers, antioxidants, and corrosion inhibitors. Also, static inhibitors, flame retardants and biocides compatible with polyolefins may be incorporated in or coated on the film layer. The various additives may be combined and included in more than one polyolefin layer or different additives or combinations thereof may be included in more than one layer. In the shrink wrap laminate with multiple polyolefin layers, additives or combinations thereof may be included in one or more of the plies.

In one embodiment, the outer thermoplastic layer includes an ultraviolet stabilizer as an additive in a mixture of low density polyethylene and linear low density polyethylene. A commercially available ultraviolet stabilizer is Chimassorb 944® by Geigy from a family of hindered amines. The stabilizer is prepared in a concentrated form in polyethylene and is blended with polyolefin prior to preparing the film. In another embodiment, the thermoplastic layer has an anticorrosive additive in linear low density polyethylene. A preferred corrosion inhibitor is anti-corrosive additive PA4733 manufactured by Northern Instruments Corporation.

The following examples illustrate some embodiments of the invention. They are merely exemplary and are not limitative of the invention as otherwise described herein. It should be understood that all numerical values are approximate.

### EXAMPLE 1

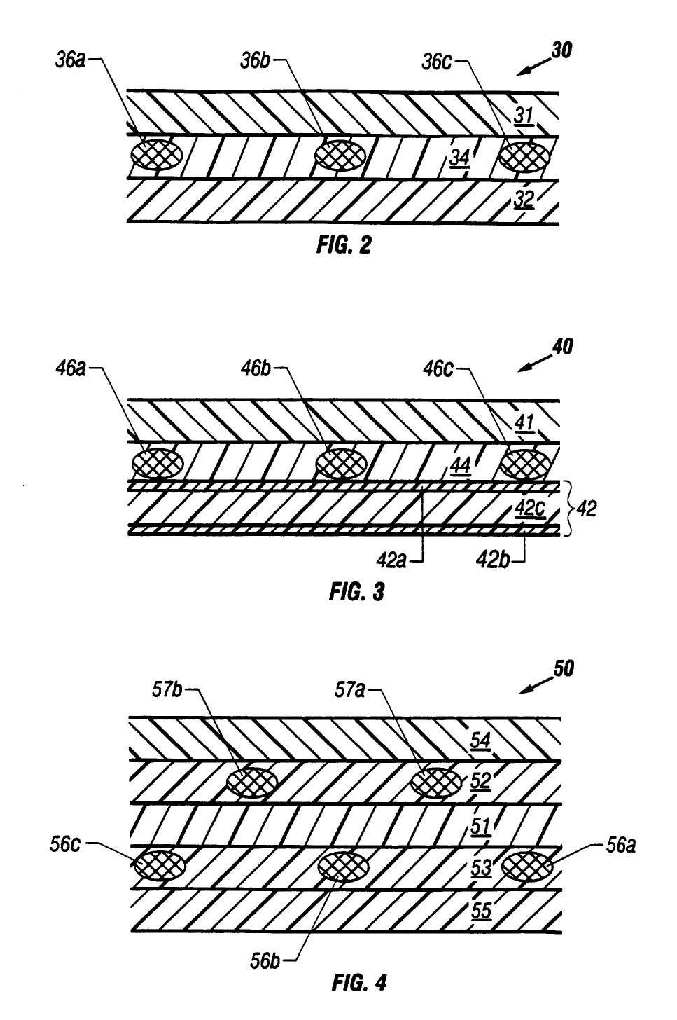

FIG. 2 is a cross-section of one embodiment of a 3-ply reinforced shrink wrap. The reinforced shrink wrap 30 includes a shrink film 31, a polyethylene sheet 32, a reinforcing grid shown as 36a, 36b, and 36c in a tie layer 34. The layer 31 is a highly irradiated polyethylene shrink film. The shrink film is Cryovac® D-925 film with a thickness of about 0.75 mil.

Layer 34 is the elastomeric tie layer. It includes about 70% of LDPE (i.e., PE-1017 by Chevron), about 25% VLDPE (i.e., Exact 4044 by Exxon), and about 5% of UV inhibitor (i.e., Chimassorb 944® by Geigy). A cross-section of the reinforcing filamentous grid 36a, 36b, and 36c is shown in layer 34. The preferred grid multi-filament nylon or polyester yarn is a non-woven 2.67×2.67 scrim (about 500 denier). Layer 32 is a LDLBPE sheet having a thickness of about 2 mils. The following Table 4 includes the properties of the reinforced shrink wrap of FIG. 2 with ASTM tests used to measure the properties.

TABLE 4
Physical Properties of 3-Ply Shrink Wrap

| | | Nominal Value | | | |
|---|---|---|---|---|---|
| Property | ASTM | U.S. System | | Metric System | |
| Thickness | D-2103 | 3.8 | mils | 0.097 | mm |
| Standard Weight | D-2103 | 20.5 | lbs/1000 ft² | 10.0 | kg/100 m² |
| 3″ Load @ Yield | | | | | |
| MD | D-882 | 92.0 | lbf | 409.2 | N |
| TD | | 95.0 | lbf | 422.6 | N |
| 3″ Load @ Break | | | | | |
| MD | D-882 | 44.0 | lbf | 195.7 | N |
| PSI | | 3850.0 | psi | 26.5 | Mpa |
| TD | | 42.0 | lbf | 186.8 | N |
| PSI | | 3680.0 | psi | 25.4 | Mpa |
| 3″ Elongation @ Break | | | | | |
| MD | | 115.0% | | 115.0% | |
| TD | | 190.0% | | 190.0% | |
| Tongue Tear | | | | | |
| MD | D-751B | 6.8 | lbf | 30.2 | N |
| TD | | 7.4 | lbf | 32.9 | N |
| Trapezoidal Tear | | | | | |
| MD | D-4533 | 17.0 | lbf | 75.6 | N |
| TD | | 19.0 | lbf | 84.5 | N |
| PPT Resistance | | | | | |
| MD | D-2582 | 18.0 | lbf | 80.1 | N |
| TD | | 18.4 | lbf | 81.8 | N |
| Seam Integrity | | | | | |
| Shear | D-4545 | 35.0 | lbf | 155.7 | N |
| Peel | | 16.0 | lbf | 71.2 | N |
| Dart Impact Strength | D-1709 | 2.4 | lbs | 1.1 | kg |

MD = Machine Direction
TD = Transverse Direction

### EXAMPLE 2

FIG. 3 shows the cross-section of another embodiment of the reinforced shrink wrap. The reinforced shrink wrap 40 includes layers 41, 42, and 44. The layer 41 is a shrink film, and the layer 44 is an elastomeric tie layer. A reinforcing grid is imbedded in the tie layer 44 with the cross-section of the grid shown at 46a, 46b, and 46c. The layer 42 is a thermoplastic layer composed of a three-ply co-extruded film. The plies are designated as 42a, 42b, and 42c, respectively. In one embodiment, the middle ply 42c is about 50% to 70% of the total thickness. The multi-ply film can be made by co-extrusion and other processes used in film production. The multi-ply film layer allows the preparation of a single film with varied characteristics for each ply. For instance, an additive that may be more effective on an outer surface, such as a corrosion inhibitor, can be added to the outer ply material prior to fabrication such that only one ply will contain the additive. Similarly, the polyolefin content can be varied for each ply so that the outer layer ply has a polyolefin content with better surface characteristics and the inner ply is formulated for strength and durability characteristics. Of course, it should be recognized that any number of plies may be used to obtain desired properties and performance.

### EXAMPLE 3

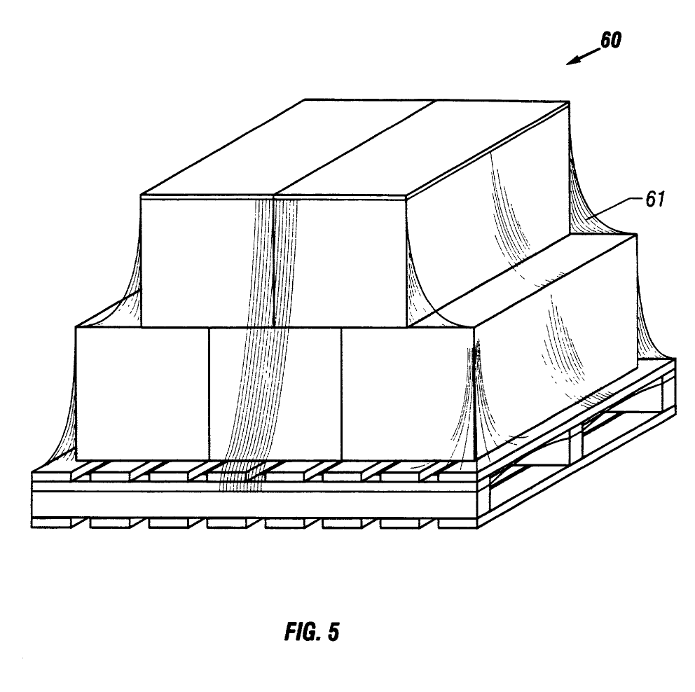

FIG. 4 shows an embodiment of a multi-layered reinforced shrink wrap 50. Layers 54, 51 and 55 can be either thermoplastic or shrink film as long as there is one layer of shrink film. Layers 52 and 53 are elastomeric tie layers with grid 57a and 57b and grid 56a, 56b and 56c disposed in layers 52 and 53, respectively. FIG. 4 is an example of a shrink wrap with double tie layers with reinforcing grids. Other embodiments with more than two tie and grid layers and multiple layers of shrink film may be made according to the properties of the product desired for the intended purpose. Table 5 lists some physical properties of a five-ply shrink wrap measured by ASTM methods.

TABLE 5
Physical Properties of 5-Ply Shrink Wrap

| | | Nominal Value | | | |
|---|---|---|---|---|---|
| Property | ASTM | U.S. System | | Metric System | |
| Thickness | D-2103 | 8.3 | mils | 0.21 | mm |
| Standard Weight | D-751 | 37.9 | lbs/1000 ft² | 18.5 | kg/100 m² |
| 3″ Load @ Yield | | | | | |
| MD | D-882 | 165.0 | lbf | 733.9 | N |
| TD | | 165.0 | lbf | 733.9 | N |
| 3″ Load @ Break | | | | | |
| MD | D-882 | 60.0 | lbf | 266.9 | N |
| PSI | | 2400 | psi | 16.5 | Mpa |
| TD | | 55.0 | lbf | 244.6 | N |
| PSI | | 2200 | psi | 15.2 | Mpa |
| 3″ Elongation @ Break | | | | | |
| MD | | 70% | | 70% | |
| TD | | 90% | | 90% | |
| Tongue Tear | | | | | |
| MD | D-2261 | 14.5 | lbf | 64.5 | N |
| TD | | 13.5 | lbf | 60.0 | N |
| Trapezoidal Tear | | | | | |
| MD | D-4533 | 30.0 | lbf | 133.4 | N |
| TD | | 32.0 | lbf | 142.3 | N |
| PPT Resistance | | | | | |
| MD | D-2582 | 24.0 | lbf | 106.8 | N |
| TD | | 25.0 | lbf | 111.2 | N |
| Seam Integrity | | | | | |
| Shear | D-4545 | 80.0 | lbf | 355.8 | N |
| Peel | | 32.0 | lbf | 142.3 | N |
| Dart Impact Strength | D-1709 | 3.75 | lbs | 1.70 | kg |
| Burst Strength | 3786 | >173 | psi | | |
| Puncture Strength | D-4833 | 56.926 | | | |

MD = Machine Direction
TD = Transverse Direction

It is noted that the 5-ply shrink wrap tested according to ASTM methods had a construction shown in FIG. 4. Both layers 54 and 55 were LDLBPE sheets with a thickness of about 2 mils. Layer 51 was a shrink film (Cryovac® D-925 film) with a thickness of about 0.75 mil. Layers 52 and 53 were elastomeric tie layers. Each tie layer included about 70% of LDPE (i.e., PE-1017 by Chevron), about 25% VLDPE (i.e., Exact 4044 by Exxon), and about 5% of UV inhibitor (i.e., Chimassorb 944® by Geigy). Cross-sections of one reinforcing filamentous grid 56a, 56b, and 56c in layer 53 and another reinforcing filamentous grid 57a and 57b in layer 52 are shown in FIG. 4. The reinforcing grid was a multi-filament nylon or polyester yarn of a non-woven 2.67×2.67 scrim (about 500 denier).

### EXAMPLE 4

FIG. 5 is an example of a pallet of crates covered by the reinforced shrink wrap in accordance with one embodiment of the invention. Covers for products, crates or packaging can be made by any method of cutting and seaming for large equipment and machinery. Large covers can be constructed by joining rolls of the reinforced shrink film with sewn seams, heat sealing, hot melt, radio or ultrasonic waves or any other available seaming method appropriate for the material. The reinforced shrink wrap can also be used for small items, and it is not intended to limit in any way the size or shape of the cover that can be made and used.

In use, the reinforced shrink wrap is placed around the package or product, and heat is applied by hot air blowers, ovens or any other means to shrink it. The shrink film deforms and conforms to the shape and size of the item covered, and the outer layers of the shrink wrap also deforms to provide a snug, reinforced, strong cover for the item. The shrink wrap is resistant to bum-through when localized heat is used to shrink the cover. It has a minimum shrinkage of about 4.5%.

As demonstrated above, embodiments of the invention combine some or all of the advantages of a reinforced plastic film with the benefits of shrink wrap. The invention combines the advantages of these two different materials and produces a laminate that is flexible, heat sealable across the whole material and exhibits fiber slippage for enhanced tear resistance and good outdoor behavior. Furthermore, utilizing a polyolefin extrusion tie layer provides a product with improved properties over those laminated with adhesives. The elastomeric tie layer also may enhance the flexibility and appearance of the finished product. The reinforcing grid minimizes tears and rips and prevents punctures from spreading. Yet, the reinforced shrink wrap deforms to fit the product or container in the same or similar manner as the conventional shrink wrap. The resulting reinforced shrink wrap has good tensile and puncture properties, but also is a soft pliable film. The puncture strength and seam integrity have been improved. Moreover, the reinforced shrink wrap is resistant to localized bum-through during the heating step used to shrink the wrap around the product. As such, the reinforced shrink wrap may be superior to the conventional non-reinforced product for packaging, handling, shipping and storage of goods. It can be used to cover all sizes of products and containers and is especially suited for covers for large equipment. Particularly, the reinforced shrink wrap is suited for protecting cargo and equipment exposed to harsh environments. In addition to reinforced shrink wrap, embodiments of the invention also provide a simple and cost-effective method for manufacturing the reinforced shrink wrap.

While the invention has been described with respect to a limited number of embodiments, modifications and variations therefrom exist. For example, any thermoplastic sheets or films may be used to manufacture the reinforced shrink wrap. Furthermore, reinforcement may be effected by use of any grid or scrim that has higher strength than thermoplastic sheets. While an extrusion lamination method is used to make the reinforced shrink wrap, other lamination methods, such as an adhesive lamination, may also be employed. Additionally, any shrinkable film may be used in embodiments of the invention. Shrinking may be effected by a variety of methods, including but not limited to heat, light, ultrasound, and so on. It should be recognized that the order of steps to practice the invention is not limited to those described. Any order that achieves the objectives and results of the invention may be practiced. The appended claims intend to cover all those modifications and variations as falling within the scope of the invention.

What is claimed is:

25. A method of making a reinforced shrink wrap comprising:
providing a sheet of thermoplastic and a shrink film;
placing a reinforcing grid on the sheet of thermoplastic;
forming a tie layer of elastomeric material between the sheet of thermoplastic and the shrink film; and
laminating the thermoplastic sheet, the shrink film, and the tie layer with the reinforcing grid to form a reinforced shrink wrap, whereby the reinforcing grid is held by the elastomeric tie layer in between the thermoplastic sheet and the shrink film, and the reinforcing grid being disposed via the elastomeric tie layer.

26. A method of making the reinforced shrink wrap of claim 25, further comprising heating the elastomeric material and applying it by extrusion coating to the thermoplastic sheet.

32. The method of claim 25 wherein the shrink film is a highly irradiated polyolefin.

33. The method of claim 32 wherein the highly irradiated polyolefin is polyethylene

34. The method of claim 25 wherein the reinforcing grid is a non-woven scrim.

35. The method of claim 34 wherein the reinforcing grid material is selected from the group consisting of nylon filament and polyester filament from about 200 to about 800 denier.

36. The method of claim 25 wherein the elastomeric tie layer has a lower modulus than the thermoplastic sheet or the shrink film.

37. The method of claim 25 wherein the thermoplastic sheet includes multiple plies of thermoplastic.

38. The method of claim 25 wherein the tie layer is from about 0.75 to about 1.5 mils in thickness.

39. The method of claim 25 wherein the thermoplastic sheet and shrink film are from about 0.75 to about 6 mils thick.

40. The method of claim 25 wherein the thermoplastic sheet or shrink film includes an additive selected from the group consisting of ultraviolet stabilizer, flame retardant, static inhibitor, color additive, antioxidant, corrosion inhibitor, biocide and mixtures thereof.

41. The method of claim 25 wherein the tie layer includes an additive selected from the group consisting of ultraviolet stabilizer, flame retardant, static inhibitor, color additive, antioxidant, corrosion inhibitor, biocide and mixtures thereof.

42. The method of claim 37 wherein at least one ply of thermoplastic contains an additive selected from the group consisting of ultraviolet stabilizer, flame retardant, static inhibitor, color additive, antioxidant, corrosion inhibitor, biocide and mixtures thereof.

43. The method of claim 33 wherein the polyethylene is selected from the group consisting of linear low density polyethylene, low density polyethylene and mixtures thereof.

44. A method of making a multi-layered reinforced shrink wrap comprising:
providing at least three layers of thermoplastic;
at least one of the thermoplastic layers is a shrink film of highly irradiated polyolefin; and
laminating at least two tie layers of elastomeric material alternatively disposed between the thermoplastic layers, each holding a reinforcing grid but allowing slippage of the reinforcing grid in the tie layer upon tensile loading.

45. The method of claim 44 wherein the shrink film of highly irradiated polyolefin is polyethylene.

46. The method of claim 44 wherein the reinforcing grid is a non-woven scrim.

47. The method of claim 44 wherein the reinforcing grid is selected from the group consisting of nylon filament and polyester filament from about 200 to about 800 denier.

48. The method of claim 44 wherein the elastomeric tie layers have a lower modulus than at least one of the thermoplastic layers.

49. The method of claim 44 wherein at least one of said thermoplastic layers includes multiple thermoplastic plies.

50. The method of claim 44 wherein each of the tie layers is from about 0.75 to about 1.5 mils in thickness.

51. The method of claim 44 wherein the thermoplastic layers are from about 0.75 to about 6 mils thick.

52. The method of claim 44 wherein at least one of the thermoplastic layers contains an additive selected from the group consisting of ultraviolet stabilizer, flame retardant, static inhibitor, color additive, antioxidant, corrosion inhibitor, biocide and mixtures thereof.
